(19) United States
(12) Patent Application Publication
(10) Pub. No.: US 2011/0273869 A1
(43) Pub. Date: Nov. 10, 2011

(54) Cost Effective Apparatus for a Heterogeneous Battery Operated Laser Illumination System

(76) Inventors: Richard Redpath, Cary, NC (US); Sarah Donan Redpath, Cary, NC (US)

(21) Appl. No.: 12/777,208

(22) Filed: May 10, 2010

(51) Int. Cl. F21L 4/00

(52) U.S. Cl. 362/183; 362/157

(57) ABSTRACT

The invention relates to a cost effective power supply system for a laser illumination lamp as a novelty toy for laser beam patterns. The system provides a unique cost effective limited part circuit design to enable the usage of a heterogeneous set of battery options for the user to operate as well as a heterogeneous set of AC adapter power sources which may have different cost structures and availability.

### BACKGROUND OF INVENTION

The present invention relates to a cost effective power supply system for a novelty toy that produces a laser pattern or matrix diffraction projection. Laser patterns or matrix diffractions are well known prior art and are available with laser pointers. These devices have specific battery requirements and cannot operate with substituted rechargeable batteries as the voltage requirements will not be met.

Other prior art consists of battery operated laser shows that have specific battery needs and AC adapter. While prior art exists for the purchase of laser pointers and laser shows with specific battery needs and AC adapters there is no lamp toy system available that can accept a heterogeneous set of battery needs for longer life operation as well as AC adapter sources for a cost effective means and availability.

In this respect, the Cost Effective Apparatus for Heterogeneous Battery Operated Laser Illumination System substantially departs from the conventional design of the modern day purchasable system prior art and in doing so provides an inexpensive laser illumination lamp as a novelty toy. Furthermore, the operation of the embodiment provides a means to utilize many battery configurations for more extended life operation.

### BRIEF SUMMARY OF INVENTION

The invention relates to cost effective power supply system for a laser illumination lamp as a novelty toy and more particular for battery operation. In view of the prior art, the present invention provides a unique cost effective limited part circuit design to enable the usage of a heterogeneous set of battery options to operate for longer life as well as a heterogeneous set of AC adapter power sources to result in an inexpensive product.

### BRIEF DESCRIPTION OF DRAWINGS

FIG. 1 is a block diagram of the embodiment operation.

FIG. 2 is a circuit diagram.

FIG. 3 circuit board design of an actual implementation.

### DETAIL DESCRIPTION OF THE INVENTION

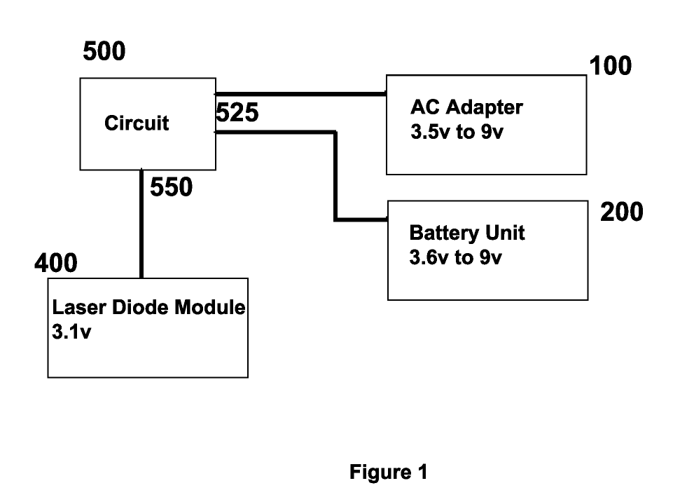

Referring to FIG. 1 a block diagram is shown, at 100 is a 3.5v to 9v AC adapter power supply that can be chosen to provide voltage input at 525 for circuit at 500. At 200 is a battery supply unit that can vary in battery combinations to supply 3.6v to 9v that can be chosen to provide input at 525 for circuit at 500. At 200 a 9v battery could be utilized for the battery unit as well as four AA batteries at 1.5v each in series or four AA rechargeable batteries at 1.2v each in series. At 400 is a laser diode module with 3.1v voltage requirements is connected to circuit output at 550 for circuit at 500. At 200 it is suggested to have batteries in series as to enable the circuit at 500 to regulate the voltage to extract as much battery life operation as possible from the battery unit than in other configurations.

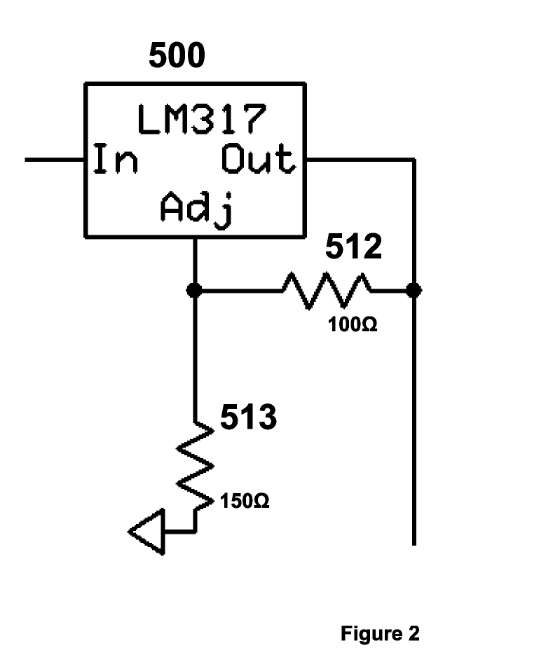

Referring to FIG. 2, a circuit diagram at 500 is shown for FIG. 1 at 500. Referring to FIG. 2, at 510 is a 3-Terminal Adjustable Regulator (LM317 National Semiconductor Corporation) that can have input of 1.2v to 37v. This Adjustable Regulator has been configured with input-to-output differential voltage with resistors at 512 and 513 to produce 3.1v output. At 512 is a 100 ohm resistor and at 513 is a 150 ohm resistor each ½ watt. Anyone skilled in the area can see that this configuration is capable of supplying the 3.1 voltage requirements with differing input voltages.

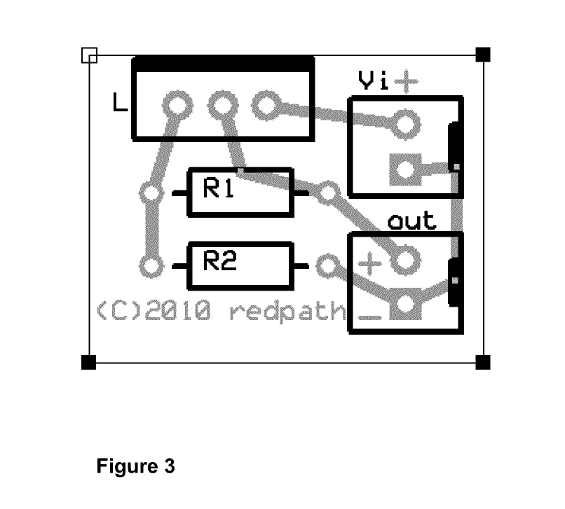

Referring to FIG. 3 is a circuit board design for the embodiment. One skilled in the area can see that the circuit board is designed to enable sufficient heat sinking and connection of components for optimal use and minimal production cost. The circuit board is 22 mm width by 18 mm height and provides a compact production of the embodiment to fit within this size.

What is claimed is:

1. A Cost Effective Apparatus for a Heterogeneous Battery Operated Laser Illumination System comprising the use of a Voltage regulator to enable the use of battery configurations for better extended life operation.

2. A Cost Effective Apparatus for a Heterogeneous Battery Operated Laser Illumination System comprising the use of a Voltage regulator to enable use of battery configurations for better extended life operation to overcome fault in performance for one or more batteries in the configuration.

3. A Cost Effective Apparatus for a Heterogeneous Battery Operated Laser Illumination System comprising the use of a Voltage regulator to enable the use of many different voltage AC Adapter units for minimal cost and availability.

4. A Cost Effective Apparatus for a Heterogeneous Battery Operated Laser Illumination System comprising the use of a Voltage regulator in claim 1 to enable the use of rechargeable batteries.
